(19) United States
(12) Patent Application Publication
(10) Pub. No.: US 2012/0047584 A1
(43) Pub. Date: Feb. 23, 2012

(54) USER REQUEST APPROVAL SYSTEM USING ADVERTISMENTS AND METHOD

(75) Inventor: TIEN-PING LIU, Tu-Cheng (TW)

(73) Assignee: HON HAI PRECISION INDUSTRY CO., LTD., Tu-Cheng (TW)

(21) Appl. No.: 13/154,585

(22) Filed: Jun. 7, 2011

(30) Foreign Application Priority Data
Aug. 19, 2010 (CN) 201010257314.1

(51) Int. Cl. G06F 21/00

(52) U.S. Cl. 726/28

(57) ABSTRACT

A user request approval system includes access to an advertisement database, an advertisement verification generation module, a user interface module and a checking module. The advertisement database stores a plurality of advertisement. The advertisement verification generation module receives advertisement from the advertisement database and generates an advertisement verification based on the advertisement. The user interface module displays the advertisement verification on a user interface and receives an input user verification. The checking module determines if the input verification corresponds to the advertisement verification.

### BACKGROUND

1. Technical Field

The disclosure generally relates to a user request approval system using advertisements and a method for approving request using advertisements.

2. Description of Related Art

A Completely Automated Public Turing test to tell Computers and Humans Apart (CAPTCHA) is a type of challenge-response test used in computing as an attempt to ensure that a response to an internet advertisement, post to a forum, or login to a website, or other common internet transactions (herein collectively referred to as a “user request” is indeed a user response and not a computer generated response. The process usually involves a computer asking a user to complete a simple test that the computer generates and grades. If the user passes the test, the computer allows the user request. However, a common type of CAPTCHA requires the user to type a user response comprising letters or digits lacking any meaning or relevance to the user request and appearing in a distorted image that appears on the screen. It is difficult for users to quickly and correctly enter a user response having no commercial or logical relationship to the subject matter of the user request.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of a user request approval system in an exemplary embodiment.

FIG. 2 is a view of a user interface in an exemplary embodiment.

FIG. 3 is a flow chart of a method for approving user request according to an exemplary embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming languages such as Java, C, or Assembly. One or more software instructions in the modules may be embedded in firmware, such as an EPROM. Modules may comprise logically connected logic units, such as gates and flip-flops, and programmable units such as programmable gate arrays or processors. The modules described herein may be implemented as software and/or hardware modules and may be stored in any type of computer-readable medium or other computer storage device.

A user request approval submitting system with advertisement response verification and method is provided to prevent standard automated software from having its user requests allowed.

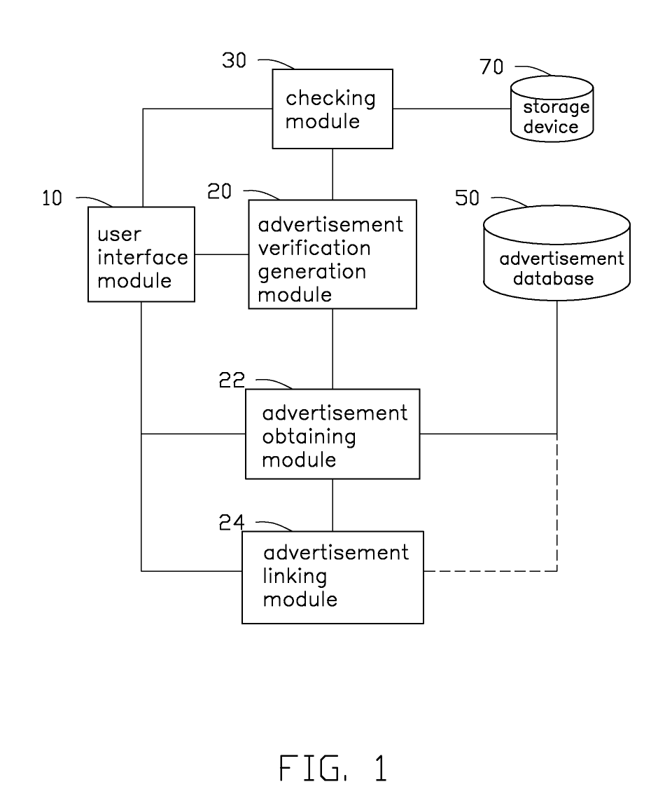

Referring to FIG. 1, in an exemplary embodiment, a user request approval system includes an advertisement database 50 or access to a remote advertisement database, an advertisement verification generating module 20, a user interface module 10, a checking module 30, a storage device 70, an advertisement obtaining module 22, and an advertisement linking module 24.

The advertisement database 50 stores a plurality of advertisements. The advertisements may be stored in form of text or image.

In an exemplary embodiment, when a user request is made, the advertisement verification generating module 20 may receive an advertisement through the advertisement obtaining module 22. The advertisement received may be selected in any way (e.g., randomly or according to an algorithm (see below)). The advertisement verification generating module 20 generates an advertisement verification based on the received advertisement. The form of the advertisement verification displayed may be in form of an image. The advertisement verification may be a simple advertised statement in words or an image, or a simple question related to the advertisement.

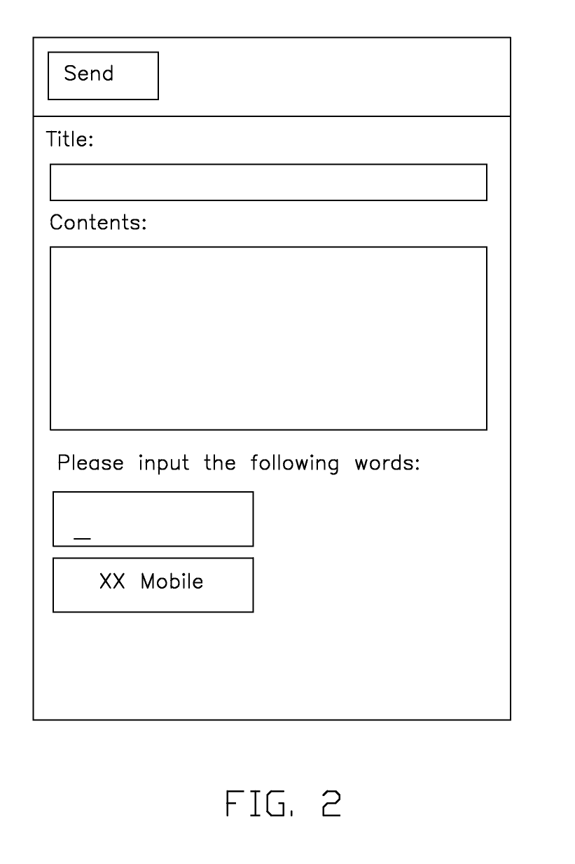

Referring to FIG. 2, the user interface module 10 is logically connected to the advertisement verification generating module 20 and the checking module 30. The user interface module 10 may provide a user interface on a web browser. The user interface may both display the advertisement verification and receive an input user verification.

The checking module 30 may be logically connected to the storage device 70. The checking module 30 may determine if the input user verification is the same, or partially same, as the advertisement verification. In other words, the checking module determines whether the input user verification is “correct”. The storage device 70 may cache the input verification from the user and the advertisement verification.

If not done randomly, the advertisement obtaining module 22 may select advertisements from the advertisement database 50 according to classifications. The advertisements in advertisement database 50 may be classified into a plurality of the advertisement classifications. For example, the classifications may include food, mobile devices, or cars. At least one of the advertisement classifications may be selected relative to the browsing history of the user, or subject matter of the current website. Alternatively, the advertisement obtaining module 22 may provide a list of advertisement classifications on the user interface to directly receive selection from the user. When one or more classifications are selected, the advertisement output to the advertisement verification generating module 20 may be selected from the one or more selected classifications. In an exemplary embodiment, the advertisements stored in the advertisement database 50 may be classified, and the advertisement obtaining module 22 may directly read classification from the advertisement database 50.

The advertisement linking module 22 may provide linkage to an advertised website relative to the selected advertisement by clicking on the advertisement verification displayed on the user interface.

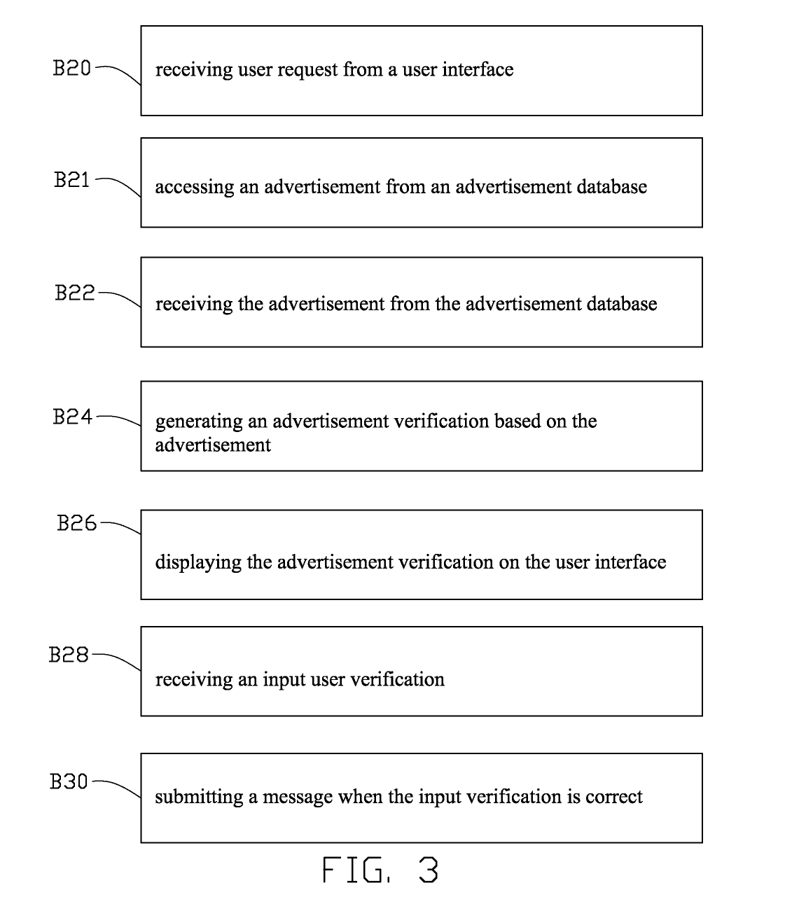

Referring to FIG. 3, a computer-implemented method for approving user request may include the following steps.

Block B20, receiving a user request from a user interface.

Block B21, accessing an advertisement from the advertisement database. Block B21 may further include: randomly selecting an advertisement from the advertisement database or providing advertisement classifications for a plurality of advertisement, and selecting the advertisement from at least one of the advertisement classifications associated with the user. In detail, the user interface displays a list of advertisement classifications and receives selections from the list of advertisement classifications from the user. Alternatively, selecting the advertisement from the advertisement database may further include; selecting the at least one of the advertisement classifications relative to the browsing history of the user, or subject of current website.

Block B22, receiving the advertisement from the advertisement database 10.

Block B24, generating an advertisement verification based on the advertisement.

Block B26, displaying the advertisement verification on the user interface.

Block B28, receiving an input user verification.

Block B30, submitting a message when the input verification is correct.

Linking to an advertised website relative to the advertisement by clicking on the advertisement verification displayed on the user interface after Block B28.

In an exemplary embodiment, the advertisement obtaining module 22 may further analyze a favorite site of the user and may promote the corresponding classifications relative to the favorite site of the user.

In an exemplary embodiment, the advertisements stored in the advertisement database may be amended or updated according to advertisement providers for keeping the advertisements fresh.

While the present disclosure has been illustrated by the description of the embodiments thereof, and while the embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

Depending on the embodiment, certain steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A user request approval system, comprising:
access to an advertisement database storing a plurality of advertisement;
an advertisement verification generation module, adapted to receive an advertisement from the advertisement database and generate an advertisement verification based on the advertisement;
a user interface module, adapted to display the advertisement verification on a user interface and receive an input user verification; and
a checking module, adapted to determine if the input user verification corresponds to the advertisement verification.

2. The user request approval system of the claim 1 further comprising:
an advertisement obtaining module, adapted to select the advertisement from the advertisement database associated with the user.

3. The user request approval system of the claim 2, wherein the advertisement obtaining module is adapted to provide advertisement classifications for the plurality of advertisements, and the advertisement is selected from at least one of the advertisement classifications associated with the user.

4. The user request approval system of the claim 3, wherein the user interface module is further adapted to display a list of advertisement classifications and adapted to receive selection on the list of advertisement classifications from the user.

5. The user request approval system of the claim 3, wherein the at least one of the advertisement classifications is selected relative to browsing history of user, or subject of current website.

6. The user request approval system of the claim 1 further comprising:
an advertisement linking module, adapted to link to an advertised website relative to the advertisement by clicking on the advertisement verification displayed on the user interface.

7. The user request approval system of the claim 1, wherein the advertisement is stored in form of text or images, and the advertisement verification is displayed in form of an image.

8. A computer-implemented method for approving user request, comprising:
receiving a user request;
accessing an advertisement from an advertisement database;
generating an advertisement verification based on the advertisement;
displaying the advertisement verification on a user interface;
receiving an input user verification; and
submitting a message when the input user verification corresponds to the advertisement verification.

9. The method of the claim 8 further comprising:
selecting the advertisement from the advertisement database associated with the user.

10. The method of the claim 9 further comprising:
providing advertisement classifications for the plurality of advertisements, and
selecting the advertisement from at least one of the advertisement classifications associated with the user.

11. The method of the claim 10 further comprising:
displaying a list of advertisement classifications; and
receiving selection on the list of advertisement classifications from the user.

12. The method of the claim 10 further comprising:
selecting the at least one of the advertisement classifications relative to browsing history of user, or subject of current website.

13. The method of the claim 8 further comprising:
linking to an advertised website relative to the advertisement by clicking on the advertisement verification displayed on the user interface.

14. The method of the claim 8, wherein the advertisement is stored in form of text or images, and the advertisement verification is displayed in form of an image.

15. A computer-implemented user request method, comprising:
providing access to an advertisement database, adapted to storing a plurality of advertisements; an advertisement verification generation module, adapted to receive an advertisement from the advertisement database and generate an advertisement verification based on the advertisement; a user interface module, adapted to display the advertisement verification on a user interface and receive an input user verification; and a checking module, adapted to determine if the input verification corresponds to the advertisement verification;
receiving a user request;
accessing the advertisement from the advertisement database;
generating the advertisement verification based on the advertisement;
displaying the advertisement verification on the user interface;
receiving the input user verification; and
submitting a message when the input verification is corresponding to the advertisement verification.
